(19) United States
(12) Patent Application Publication
(10) Pub. No.: US 2025/0137976 A1
(43) Pub. Date: May 1, 2025

(54) ULTRASONIC PHASED ARRAY-BASED IN-SITU IMAGING METHOD FOR MELT FLOW IN INJECTION MOLDING

(71) Applicant: Zhejiang University, Hangzhou City (CN)

(72) Inventors: Peng ZHAO, Hangzhou City (CN); Kaipeng Ji, Hangzhou City (CN); Ruoxiang Gao, Hangzhou City (CN); Hao Chen, Hangzhou City (CN); Wei Zhang, Hangzhou City (CN); Chengqian Zhang, Hangzhou City (CN); Jianzhong Fu, Hangzhou City (CN)

(21) Appl. No.: 18/925,262

(22) Filed: Oct. 24, 2024

(30) Foreign Application Priority Data
Oct. 25, 2023 (CN) 202311387886.5

(51) Int. Cl. G01N 29/44; B29C 45/77; G01N 29/02; G01N 29/26

(52) U.S. Cl. CPC G01N 29/44; B29C 45/77; G01N 29/02; G01N 29/262; B29C 2945/76063; B29C 2945/76066; B29C 2945/761; B29C 2945/76287; B29C 2945/76381; B29C 2945/76474; B29C 2945/76939; G01N 2291/022; G01N 2291/106

(57) ABSTRACT

Provided by the present disclosure is an ultrasonic phased array-based in-situ imaging method for melt flow in injection molding. The ultrasonic phased array is used for the detection of an injection molding process for the first time, and an effective dynamic monitoring imaging method for a melt front position is developed. A melt flow process in a mold cavity is dynamically monitored by collecting an FMC (Full matrix capture) dataset online. A mapping relationship between an incident angle and a target pixel point is established to rapidly determine time delay of each point in a measurement target region, and a melt bottom image is acquired using TFM (Total focusing method) imaging conditions, from which the melt front can be localized. The provided method is high in measurement accuracy, short in imaging time, and capable of effectively improving imaging efficiency of online measurement.

### CROSS-REFERENCE TO RELATED APPLICATION

This patent application claims the benefit and priority of Chinese Patent Application No. 202311387886.5 filed with the China National Intellectual Property Administration on Oct. 25, 2023, the disclosure of which is incorporated by reference herein in its entirety as part of the present application.

### TECHNICAL FIELD

The present disclosure belongs to the technical field of online detection, and in particular to an ultrasonic phased array-based in-situ imaging method for melt flow in injection molding.

### BACKGROUND

The injection process can produce parts with complex shapes without secondary processing, which has high mass production efficiency, and is the most important means to mold high-performance polymer products, accounting for more than 80% of the production of such products. During the injection, the flow velocity and front of the melt in the mold directly determine a microstructure of the product, e.g., molecular orientation and crystallinity, and then affect final macro-dimensional accuracy and mechanical properties of the product. Therefore, the accurate characterization and analysis of the melt flow velocity in the mold cavity in the filling process is the basis of the final performance analysis and process parameter optimization. However, due to the obstruction of the mold, the injection process is a black box.

Ultrasound is a widely used nondestructive testing technology, which can penetrate a melt mold and provide abundant melt information feedback. In addition, the ultrasonic probe has unique advantages of high reliability, high sensitivity and convenient operation and installation. Therefore, the ultrasound has been widely used in the monitoring of the injection molding process. Cheng et al. measured the ultrasonic velocity of the melt in the cavity to characterize different injection stages in injection molding. He distinguished fusible materials from immiscible materials by measuring the change of an attenuation coefficient. Zhao et al. described the change of foam structures caused by ultrasonic process signals during microporous injection molding. In addition, Zhao et al. put forward a mathematical model of polymer orientation and ultrasonic longitudinal velocity, and measured a melt orientation by an ultrasonic probe during injection molding. Dong et al. established an ultrasonic propagation model, which can recover density information from an ultrasonic signal to effectively measure a melt density in the injection process online. However, existing ultrasonic on-line measurement cases for injection molding all use single ultrasonic probe (single element), which can only provide melt information of a single site, and most methods are still in a qualitative characterization stage.

Multiple ultrasonic elements are integrated into one probe in the ultrasonic phased array, and each element can excite and receive an ultrasonic signal, so the phased array can detect and image the entire region within the coverage area, and greatly expands the measurement range in comparison with the ultrasonic single probe. Phased array can perform full matrix capture (FMC), in which the elements are excited in sequence, and all elements record ultrasonic signals. FMC data set contains complete information of the measurement region, which has higher imaging ability and resolution compared with other data collection technologies. Through an appropriate imaging method, a reflector in the measurement region can be recovered from the FMC data set. A total focusing method (TFM) is as highly accepted as the gold standard of ultrasonic imaging, which focuses all sound beams on each pixel in the measurement region through a time delay operator. The TFM has extremely high robustness and signal-to-noise ratio. However, when the TFM is applied to the multi-layer structure, time-consuming calculation of propagation path limits imaging efficiency.

### SUMMARY

In order to solve the problem in the prior art, an ultrasonic phased array-based in-situ imaging method for melt flow in injection molding is provided. The measurement method can measure a wavefront position and flow velocity of a polymer melt in a cavity on-line without affecting the injection molding process.

An ultrasonic phased array-based in-situ imaging method for melt flow in injection molding includes the following steps:
(1) collecting FMC data of a multi-layer structure during injection;
(2) inputting sound velocity and a thickness of each layer in the multi-layer structure to calculate a propagation displacement distribution in a measurement region;
(3) acquiring an incident angle distribution in the measurement region by inversely mapping the propagation displacement distribution in the measurement region, and calculating time delay in the measurement region according to the incident angle distribution;
(4) performing imaging processing on the FMC data using a total focusing imaging condition according to the obtained time delay, so as to obtain a melt bottom image;
(5) integrating imaging results of all moments during the injection to synthesize a melt flow front video for visualization of a melt marching process; and
(6) extracting a melt bottom imaging history, a melt front history and melt flow velocity from the obtained melt flow front video to achieve melt in-situ imaging.

In Step (6), a melt in-situ imaging result includes a melt bottom imaging history, a melt front history, and melt flow velocity.

In this embodiment, a calculation equation of the propagation displacement distribution f(θ₁, d_{(k,z)}) in the measurement target region is as follows:

$$f ( {θ}_{1} , {d}_{( k , z )} ) = {\sum }_{m = 1}^{k - 1} {d}_{m} tan [ {sin}^{- 1} ( \frac{{c}_{m} sin {θ}_{1}}{{c}_{1}} ) ] + {d}_{( k , z )} tan [ {sin}^{- 1} ( \frac{{c}_{k} sin {θ}_{1}}{{c}_{1}} ) ]$$

in the equation, k denotes a number of layers of the multi-layer structure, dₘ denotes a thickness of a m-th layer, cₘ denotes sound velocity of the m-th layer, c₁ denotes sound velocity of a first layer, θ₁ denotes an incident angle, and d_{(k,z)} denotes a depth of the measurement region.

In this embodiment, a calculation equation of the time delay t_{delay} is as follows:

$${t}_{delay} = {\sum }_{m = 1}^{k - 1} \frac{{d}_{m}}{{c}_{m} \cdot cos [ {sin}^{- 1} ( \frac{{c}_{m} sin {θ}_{1}}{{c}_{1}} )} + \frac{{d}_{( k , z )}}{{c}_{k} \cdot cos [ {sin}^{- 1} ( \frac{{c}_{k} sin {θ}_{1}}{{c}_{1}} ) ]}$$

in the equation, k denotes the number of layers of the multi-layer structure, dₘ denotes the thickness of the m-th layer, cₘ denotes sound velocity of the m-th layer, c₁ denotes sound velocity of the first layer, θ₁ denotes an incident angle, and d_{(k,z)} denotes a depth of the measurement region.

In this embodiment, an imaging condition for performing imaging processing on the FMC data using a total focusing method according to the obtained time delay is as follows:

$$I ( x , z ) = \vert {\sum }_{s = 1}^{N} {\sum }_{r = 1}^{N} \hat{D} ( {x}_{r} , {x}_{s} , {t}_{delay} ( x , z , {x}_{r} , {x}_{s} ) ) \vert$$

in the equation, I(x, z) denotes an imaging result, t_{delay} denotes the time delay, xₛ denotes a position of a s-th exciting element, and xᵣ denotes a position of a r-th receiving element, N denotes the number of elements, x denotes a coordinate in a horizontal direction, and z denotes a depth.

$$\hat{D} ( {x}_{r} , {x}_{s} , t ) = D ( {x}_{r} , {x}_{s} , t ) + i H [ D ( {x}_{r} , {x}_{s} , t ) ]$$

where D(xᵣ, xₛ, t) denotes the FMC data, i is an imaginary unit, and H denotes Hilbert transformation.

In this embodiment, in Step (6), the melt bottom imaging history is obtained by integrating pixel intensities of all imaging results at the melt bottom position. The melt front history is obtained by extracting a melt front position corresponding to each time point from the melt bottom imaging history. The melt flow velocity is obtained by solving a slope of the melt front history.

The theoretical derivation is as follows:

### 1.1. Online Measurement Strategy

An ultrasonic phased array probe is installed on a movable mold of a mold, and elements are excited in turn, and ultrasonic wave penetrates through a movable mold and a polymer melt and is reflected at the bottom surface of the melt. A reflection signal is received by all elements in the phased array and output as full matrix data (FMC data). For a N-element phased array, the FMC data is composed of N² A-scan signals, and is denoted using D(xᵣ, xₛ, t), where xₛ is a position of a s-th exciting element, and xᵣ is a position of a r-th receiving element. The FMC data includes all information of the measurement region, and an image with high resolution and high precision can be generated through the imaging method. The ultrasonic phased array may detect the whole process of injection molding online and acquire a group of FMC data. At different time of the injection stage, the difference between the FMC data is mainly caused by the difference of the melt front positions. The ultrasonic wave may be transmitted into the polymer melt and reflected at the bottom of the polymer melt, and completely reflected at an air interface. A diagonal signal of the FMC data is a self-transmitting and self-receiving signal of each element in the phased array, and corresponds to B-scan data. There is echo at a position filled with melt, but there is no bottom echo in the cavity, so a B-scan data set can characterize the melt front position of the melt, but not intuitively. Therefore, a clear melt bottom image can be acquired by directly processing the FMC data by using the imaging method, which can directly reflect the progress of the injection stage and the position of the melt front.

### 1.2 Efficient Full-Matrix Imaging Method

A total focusing method (TFM) is a standard full-matrix imaging method, which has strong robustness and adaptability. A time-domain Green's function can be used to approximate sound wave propagation after excitation and reflection. Therefore, a TFM image is reconstructed into a coherent sum of N² signals D(xᵣ, xₛ, t) after proper time delay, which is recorded as:

$$I ( x , z ) = \vert {\sum }_{s = 1}^{N} {\sum }_{r = 1}^{N} \hat{D} ( {x}_{r} , {x}_{s} , {t}_{delay} ( x , z , {x}_{r} , {x}_{s} ) ) \vert \qquad ( 1 )$$

where I(x, z) denotes an imaging result, t_{delay} denotes time delay, xₛ denotes a position of a s-th exciting element, and xᵣ denotes a position of a r-th receiving element, N denotes the number of elements, x denotes the coordinates in a horizontal direction, and z denotes a depth.

$$\hat{D} ( {x}_{r} , {x}_{s} , t ) = D ( {x}_{r} , {x}_{s} , t ) + i H [ D ( {x}_{r} , {x}_{s} , t ) ] \qquad ( 2 )$$

D(xᵣ, xₛ, t) denotes FMC data, i is an imaginary unit, and H denotes Hilbert transformation.

The movable mold and the polymer melt form a two-layer structure, where the measurement region is located on a second layer. In a case that a wedge is used to isolate the phased array from the mold, the measurement region is located on a third layer. Such a multi-layer structure complicates a propagation trajectory of a sound beam.

In this case, an effective ray tracing method is adopted to calculate the time delay. As shown in FIG. 2A, the ray reaches a point P after penetrating through the front k−1 layers of media. θ₁ is an incident angle, each of θ₂, . . . θₖ is a refraction angle, each of E₁, . . . Eₖ₋₁ is a refraction point, each of d₁, . . . dₖ is a thickness of each layer, and each of c₁, . . . cₖ is sound velocity of each layer. The total horizontal propagation distance satisfies the following equation:

$$Δ x = \overline{S {P}^{x}} = \overline{{SE}_{1}^{x}} + {\sum }_{m = 2}^{k - 1} \overline{{E}_{m - 1} {E}_{m}^{x}} + \overline{{E}_{k - 1} {P}^{x}} = {\sum }_{m = 1}^{k} {d}_{m} tan {θ}_{m} \qquad ( 3 )$$

A relationship between the incident angle and the refraction angle satisfies the Snell theorem to ensure the minimum propagation time:

$$\frac{sin {θ}_{1}}{{c}_{1}} = … = \frac{sin {θ}_{m}}{{c}_{m}} = … = \frac{sin {θ}_{k}}{{c}_{k}} \qquad ( 4 )$$

Therefore, all refraction angles can be written as functions of the incident angle θ₁:

$${θ}_{m} = {sin}^{- 1} ( \frac{{c}_{m} sin {θ}_{1}}{{c}_{1}} ) \qquad ( 5 )$$

Further, the horizontal propagation distance (propagation displacement distribution) can be written as a function of the incident angle θ₁:

$$f ( {θ}_{1} ) = {\sum }_{m = 1}^{k} {d}_{m} tan [ {sin}^{- 1} ( \frac{{c}_{m} sin {θ}_{1}}{{c}_{1}} ) ] \qquad ( 6 )$$

A definition domain of θ₁ is as follows:

$${θ}_{1} ϵ [ - {sin}^{- 1} ( \frac{{c}_{1}}{max ( {c}_{m} )} ) , {sin}^{- 1} ( \frac{{c}_{1}}{max ( {c}_{m} )} ) ] \qquad ( 7 )$$

Apparently, f(θ₁) is a monotonically increasing function, that is, for any measurement depth d_{(k,z)}, there is a one-to-one mapping relationship between the incident angle θ₁ and horizontal propagation distance:

$$f ( {θ}_{1} , {d}_{( k , z )} ) = {\sum }_{m = 1}^{k - 1} {d}_{m} tan [ {sin}^{- 1} ( \frac{{c}_{m} sin {θ}_{1}}{{c}_{1}} ) ] + {d}_{( k , z )} tan [ {sin}^{- 1} ( \frac{{c}_{k} sin {θ}_{1}}{{c}_{1}} ) ] \qquad ( 8 )$$

Therefore, by establishing a mapping dictionary between each pixel point in the measurement region and the incident angle θ₁, ray paths of all pixel points in an imaging region can be effectively obtained. The mapping relationship of a three-layer medium is shown in FIG. 2B, in which c₁, c₂ and c₃ are set to be 2235 m/s, 5900 m/s and 1300 m/s, respectively, and d₁, d₂ and d₃ are set to be 20 mm, 20 mm and 5 mm, respectively. As can be seen from FIG. 2B, in a region with small propagation distance, the function is close to linearity, and the nonlinearity increases with the increase of the propagation distance. In a case that d₃ is taken as a variable, a radiation pattern in a third layer of medium can be obtained, as shown in FIG. 2C. Further, through the mapping relationship, an incident angle distribution on the third layer of medium can be quickly obtained, as shown in FIG. 2C. The ray path can be easily determined by means of the incident angle. According to the incident angle θ₁ distribution, the time delay t_{delay} in the measurement region is calculated by the following equation:

$${t}_{delay} = {\sum }_{m = 1}^{k - 1} \frac{{d}_{m}}{{c}_{m} \cdot cos [ {sin}^{- 1} ( \frac{{c}_{m} sin {θ}_{1}}{{c}_{1}} ) ]} + \frac{{d}_{( k , z )}}{{c}_{k} \cdot cos [ {sin}^{- 1} ( \frac{{c}_{k} sin {θ}_{1}}{{c}_{1}} ) ]} . \qquad ( 9 )$$

Compared with the prior art, the present disclosure has beneficial effects as follows:

According to an ultrasonic phased array-based in-situ imaging method for melt flow in injection molding provided by the present disclosure, the ultrasonic phased array is used for the detection of an injection molding process for the first time, and an effective dynamic monitoring imaging method for a melt front position is developed. A melt flow process in a mold cavity is dynamically monitored by collecting an FMC dataset online. A mapping relationship between an incident angle and a target pixel point is established to rapidly determine time delay of each point in a measurement target region, and a melt bottom image is acquired using TFM imaging conditions, from which the melt front can be localized. A measurement method according to the present disclosure is high in measurement accuracy, short in imaging time, and capable of effectively improving imaging efficiency of online measurement.

### BRIEF DESCRIPTION OF THE DRAWINGS

FIG. 1 is a flow diagram of an embodiment provided by the present disclosure;

FIG. 2A is a diagram showing a ray path in a multiple medium layers, FIG. 2B is a curve graph showing a curve f(θ₁) when a thickness of a third medium layer d₃=5 mm, FIG. 2C is a diagram showing a propagation displacement distribution in the third medium layer, and showing an incident angle distribution in a third medium layer;

FIG. 3A is a diagram showing an in-situ measurement system for injection molding, and FIG. 3B is a schematic diagram showing installation positions of a mold cavity and an ultrasonic phased array probe;

FIGS. 4A-4F are ultrasonic phased array measurement results of a melt front position immediately after injection for different injection time, where the injection time in FIG. 4A is 3 s, the injection time in FIG. 4B is 4 s, the injection time is in FIG. 4C 5 s, the injection time in FIG. 4D is 6 s, the injection time in FIG. 4E is 7 s, and the injection time in FIG. 4F is 8 s;

FIGS. 5A-5F are diagrams showing imaging histories of a melt bottom for different injection time, where the injection time in FIG. 5A is 3 s, the injection time in FIG. 5B is 4 s, the injection time in FIG. 5C is 5 s, the injection time in FIG. 5D is 6 s, the injection time in FIG. 5E is 7 s, and the injection time in FIG. 5F is 8 s;

FIG. 6A is a diagram showing a history of a melt front position for different injection time, and FIG. 6B is a diagram of a relationship between a length of a part measured by an ultrasonic phased array and an actual length of the part;

FIGS. 7A-7F are partial diagrams of an imaging result every 0.4 s after a melt reaches a first element at different injection velocities, where the injection velocity in FIG. 7A is 4%, the injection velocity in FIG. 7B is 5%, the injection velocity in FIG. 7C is 6%, the injection velocity in FIG. 7D is 7%, the injection velocity in FIG. 7E is 8%, and the injection velocity in FIG. 7F is 9%;

FIGS. 8A-8F are diagrams showing a melt bottom imaging history at different injection velocity, where the injection velocity in FIG. 8A is 4%, the injection velocity in FIG. 8B is 5%, the injection velocity in FIG. 8C is 6%, the injection velocity in FIG. 8D is 7%, the injection velocity in FIG. 8E is 8%, and the injection velocity in FIG. 8F is 9%;

FIG. 9A is a diagram showing a melt front position history at different injection velocities, and FIG. 9B is a diagram showing a relationship between a flow velocity of the melt measured by an ultrasonic phased array and a predetermined injection velocity.

### DETAILED DESCRIPTION OF THE EMBODIMENTS

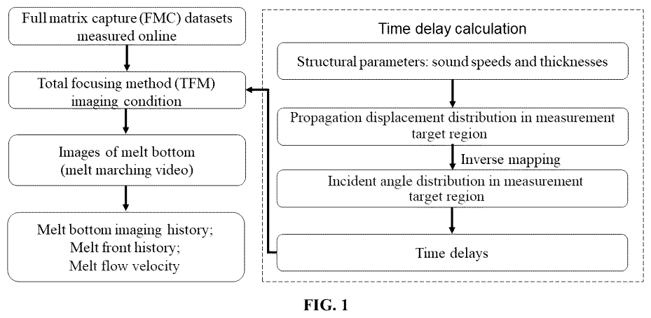

As shown in FIG. 1, an ultrasonic phased array-based in-situ imaging method for melt flow in injection molding includes the following steps.
(1) FMC data of a multi-layer structure during injection is collected.

An ultrasonic phased array probe is installed on a movable mold of a mold, and elements are excited in turn, and ultrasonic wave penetrates through a movable mold and a polymer melt and is reflected at the bottom surface of the melt. A reflection signal is received by all elements in the phased array and output as full matrix data (FMC data). For a N-element phased array, the FMC data is composed of N² A-scan signals, and is denoted using D(xᵣ, xₛ, t), where xₛ is a position of a s-th exciting element, xᵣ is a position of a r-th receiving element, and t denotes time.
(2) Sound velocity and a thickness of each layer in the multi-layer structure are input to calculate a propagation displacement distribution of a measurement region. A calculation equation of the propagation displacement distribution f(θ₁, d_{(k,z)}) in the measurement region is as follows:

$$f ( {θ}_{1} {d}_{( k , z )} ) = {\sum }_{m = 1}^{k - 1} {d}_{m} tan [ {sin}^{- 1} ( \frac{{c}_{m} sin {θ}_{1}}{{c}_{1}} ) ] + {d}_{( k , z )} tan [ {sin}^{- 1} ( \frac{{c}_{k} sin {θ}_{1}}{{c}_{1}} ) ] ,$$

in the equation, k denotes the number of layers of the multi-layer structure, dₘ denotes a thickness of a m-th layer, cₘ denotes sound velocity of the m-th layer, c₁ denotes sound velocity of a first layer, θ₁ denotes an incident angle, and d_{(k,z)} denotes a depth of the measurement region.

The movable mold and the polymer melt form a two-layer structure, where the measurement region is located on a second layer. In a case that a wedge is used to isolate the phased array from the mold, the measurement region is located on a third layer. Such a multi-layer structure complicates a propagation trajectory of a sound beam.

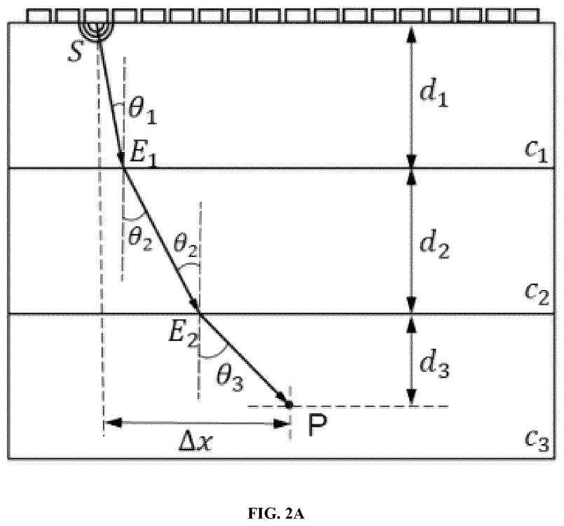

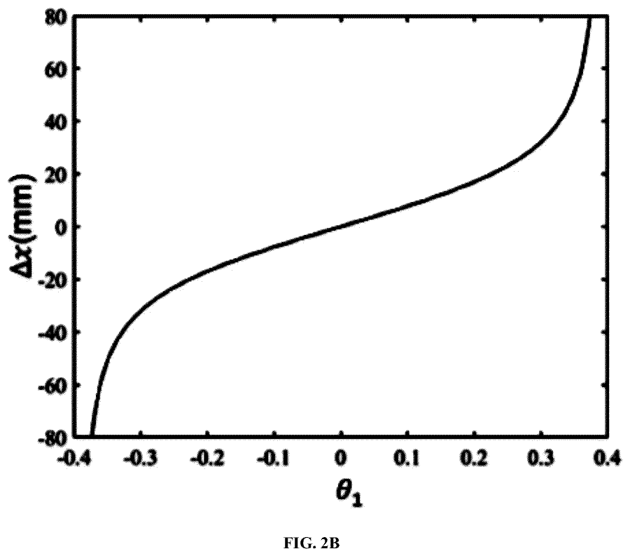

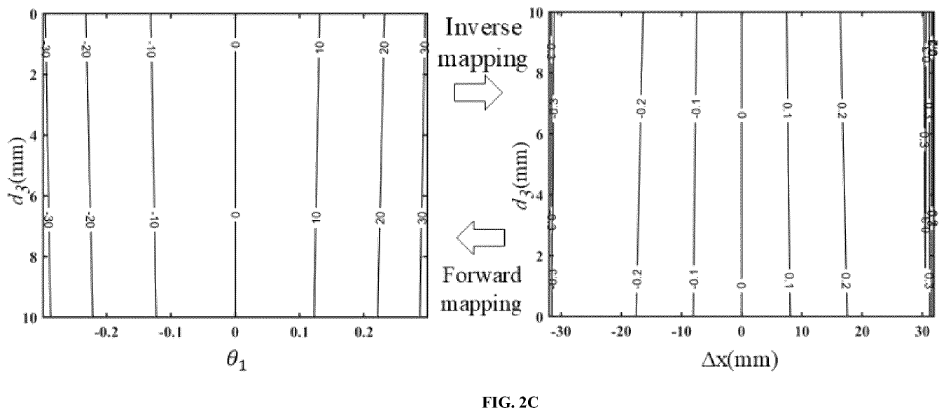

In this case, an effective ray tracing method is adopted to calculate the time delay. As shown in FIG. 2A, the ray reaches a point P after penetrating through the front k−1 layers of media. θ₁ is an incident angle, each of θ₂, . . . θₖ is a refraction angle, each of E₁, . . . Eₖ₋₁ is a refraction point, each of d₁, . . . dₖ is a thickness of each layer, and each of c₁, . . . cₖ is sound velocity of each layer. The total horizontal propagation distance satisfies the following equation:

$$Δ x = \overline{S {P}^{x}} = \overline{{SE}_{1}^{x}} + {\sum }_{m = 2}^{k - 1} \overline{{E}_{m - 1} {E}_{m}^{x}} + \overline{{E}_{k - 1} {P}^{x}} = {\sum }_{m = 1}^{k} {d}_{m} tan {θ}_{m} \qquad ( 1 )$$

A relationship between the incident angle and the refraction angle satisfies the Snell theorem to ensure the minimum propagation time:

$$\frac{sin {θ}_{1}}{{c}_{1}} = … = \frac{sin {θ}_{m}}{{c}_{m}} = … = \frac{sin {θ}_{k}}{{c}_{k}} \qquad ( 2 )$$

Therefore, all refraction angles can be written as functions of the incident angle θ₁:

$${θ}_{m} = {sin}^{- 1} ( \frac{{c}_{m} sin {θ}_{1}}{{c}_{1}} ) \qquad ( 3 )$$

Further, the horizontal propagation distance (propagation displacement distribution) can be written as a function of the incident angle θ₁:

$$f ( {θ}_{1} ) = {\sum }_{m = 1}^{k} {d}_{m} tan [ {sin}^{- 1} ( \frac{{c}_{m} sin {θ}_{1}}{{c}_{1}} ) ] \qquad ( 4 )$$

A definition domain of θ₁ is as follows:

$${θ}_{1} ϵ [ - {sin}^{- 1} ( \frac{{c}_{1}}{max ( {c}_{m} )} ) , {sin}^{- 1} ( \frac{{c}_{1}}{max ( {c}_{m} )} ) ] \qquad ( 5 )$$

Apparently, f(θ₁) is a monotonically increasing function, that is, for any measurement depth d_{(k,z)}, there is a one-to-one mapping relationship between the incident angle θ₁ and horizontal propagation distance:

$$f ( {θ}_{1} , {d}_{( k , z )} ) = {\sum }_{m = 1}^{k - 1} {d}_{m} tan [ {sin}^{- 1} ( \frac{{c}_{m} sin {θ}_{1}}{{c}_{1}} ) ] + {d}_{( k , z )} tan [ {sin}^{- 1} ( \frac{{c}_{k} sin {θ}_{1}}{{c}_{1}} ) ] \qquad ( 6 )$$

Therefore, by establishing a mapping dictionary between each pixel point in the measurement region and the incident angle θ₁, ray paths of all pixel points in an imaging region can be effectively obtained. The mapping relationship of a three-layer medium is shown in FIG. 2B, in which c₁, c₂ and c₃ are set to be 2235 m/s, 5900 m/s and 1300 m/s, respectively, and d₁, d₂ and d₃ are set to be 20 mm, 20 mm and 5 mm, respectively. As can be seen from FIG. 2B, in a region with small propagation distance, the function is close to linearity, and the nonlinearity increases with the increase of the propagation distance. In a case that d₃ is taken as a variable, a radiation pattern in a third layer of medium can be obtained, as shown in FIG. 2C. Further, through the mapping relationship, an incident angle θ₁ distribution on the third layer of medium can be quickly obtained, as shown in FIG. 2C.
(3) An incident angle θ₁ distribution of the measurement region can be acquired by inversely mapping the propagation displacement distribution of the measurement region. According to the incident angle θ₁ distribution, the time delay t_{delay} in the measurement region is calculated. A calculation equation of the time delay t_{delay} is as follows:

$${t}_{delay} = {\sum }_{m = 1}^{k - 1} \frac{{d}_{m}}{{c}_{m} \cdot cos [ {sin}^{- 1} ( \frac{{c}_{m} sin {θ}_{1}}{{c}_{1}} ) ]} + \frac{{d}_{( k , z )}}{{c}_{k} \cdot cos [ {sin}^{- 1} ( \frac{{c}_{k} sin {θ}_{1}}{{c}_{1}} ) ]} \qquad ( 7 )$$

(4) The FMC data is subjected to imaging processing using a total focusing imaging condition according to the obtained time delay, so as to obtain a melt bottom image.

A diagonal signal of the FMC data is a self-transmitting and self-receiving signal of each element in the phased array, and corresponds to B-scan data. There is echo at a position filled with melt, but there is no bottom echo in the cavity, so a B-scan data set can characterize the melt front position of the melt, but not intuitively. Therefore, a clear melt bottom image can be acquired by directly processing the FMC data by using the imaging method, which can directly reflect the progress of the injection stage and the position of the melt front.

A total focusing method (TFM) is a standard full-matrix imaging method, which has strong robustness and adaptability. A time-domain Green's function can be used to approximate sound wave propagation after excitation and reflection. Therefore, a TFM image is reconstructed into a coherent sum of N² signals D(xᵣ, xₛ, t) after proper time delay, which is recorded as:

$$I ( x , z ) = \vert {\sum }_{s = 1}^{N} {\sum }_{r = 1}^{N} \hat{D} ( {x}_{r} , {x}_{s} , {t}_{delay} ( x , z , {x}_{r} , {x}_{s} ) ) \vert \qquad ( 8 )$$

where I(x, z) denotes an imaging result, x denotes the coordinates in a horizontal direction, and z denotes a depth.

$$\hat{D} ( {x}_{r} , {x}_{s} , t ) = D ( {x}_{r} , {x}_{s} , t ) + iH [ D ( {x}_{r} , {x}_{s} , t ) ] \qquad ( 9 )$$

where i is an imaginary unit, and H is Hilbert transformation.
(5) Imaging results of all moments during the injection are integrated to synthesize a melt flow front video for the visualization of a melt marching process.
(6) A melt bottom imaging history, a melt front history and melt flow velocity are extracted from the obtained melt flow front video to achieve melt in-situ imaging.

The melt bottom imaging history is obtained by integrating pixel intensities of all imaging results at the melt bottom position. The melt front history is obtained by extracting a melt front position corresponding to each time point from the melt bottom imaging history. The melt flow velocity is obtained by solving a slope of the melt front history.

### Practical Application

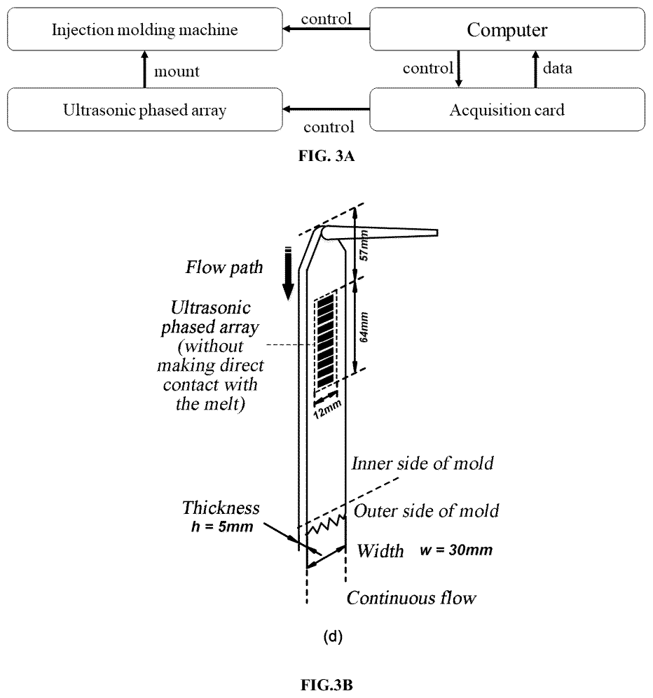

The following experiment adopts the on-line measurement method in the above embodiment for measurement, in which an ultrasonic phased array probe is used to monitor a melt flow process in a cavity during injection molding online, and a measurement system is built as shown in FIG. 3A. An injection machine used is DE168 (Tederic, China), a high temperature ultrasonic phased array (2.25L64-1.0×12-HT, Doppler, China) is installed in an injection mold, and a probe is connected to an acquisition card (M2M panther, Eddyfi, France) by a cable. The acquisition card is configured to collect FMC data in the injection process, and input the FMC data into a computer. The phased array is installed on a core of a movable mold without making contact with a polymer melt, which has no influence on the molding process. A cavity of a rheological mold used in this experiment is of a slit die-like structure with an unsealed bottom, and a symmetry plane of the phased array coincides with that of the cavity, as shown in FIG. 3B. By using such a mold structure, the stable melt flow can be obtained, which is beneficial to study the measurement principle in the injection process. The phased array has 64 elements, a spacing between the elements is 1 mm, and the central frequency is 2.25 MHz. Mold steel (sound velocity is 5912 m/s) and the polymer melt form a two-layer structure in the measurement region. Polypropylene (PP Y101, Sumitomo, Japan) is used as the polymer melt in the experiment, and the sound velocity of the PP melt is 1294 m/s. For FMC data collection, a sampling frequency is 62.5 MHz, and the delay and time range are 7 μs and 14 μs, respectively.

### 1. Short-Shot Experiment

In the short-shot experiment, the melt is allowed to flow in the measurement range of the phased array, so as to verify the measurement accuracy of a wavefront position. The process parameters are shown in Table 1, where the injection time is increased from 3 s to 8 s (the injection velocity is 2%), so as to obtain short-shot products with different melt front positions, and there is no packing process in the experiment. Collection time of the FMC data is 10.5 s, with an interval of 0.05 s.

TABLE 1
Process parameter setting of short-shot experiment

| Process parameter | Predetermined value |
|---|---|
| Mold temperature (° C.) | 70 |
| Melt temperature (° C.) | 240 |
| Injection time (s) | 3, 4, 5, 6, 7, 8 |
| Packing pressure (bar) | 0 |
| Cooling time (s) | 15 |

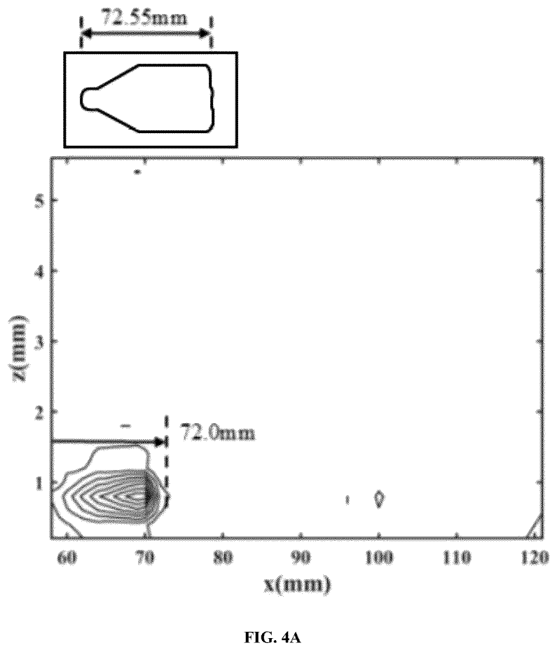

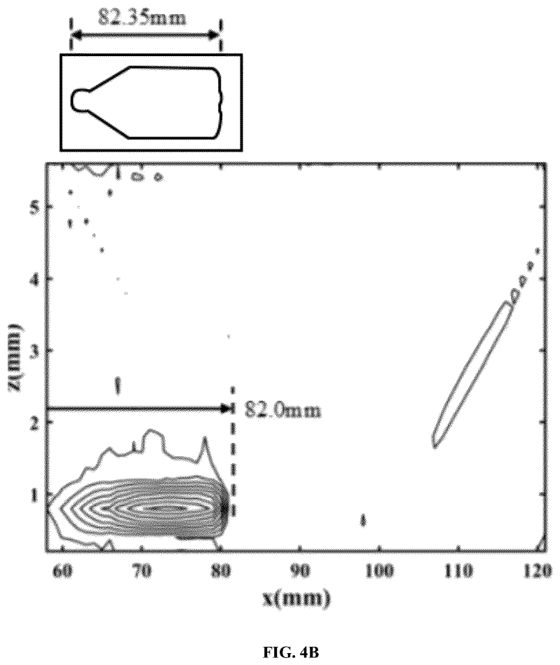

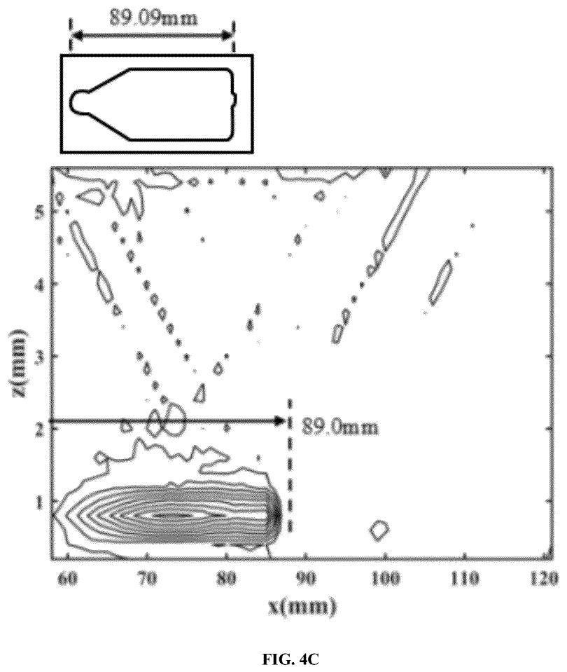

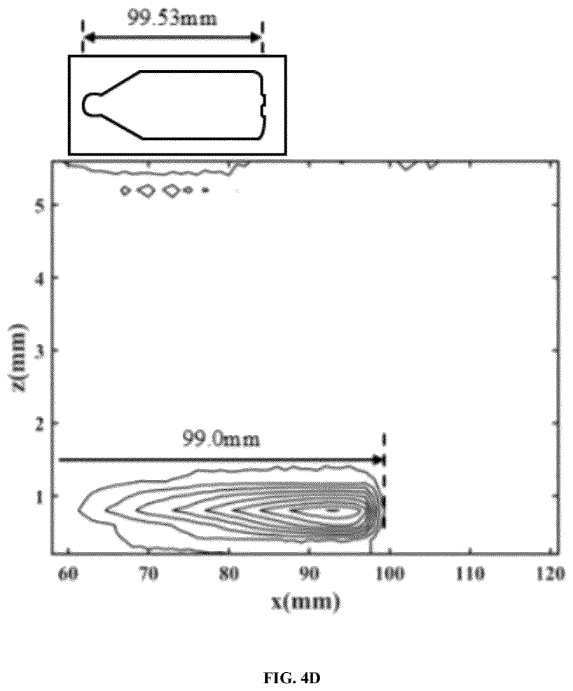

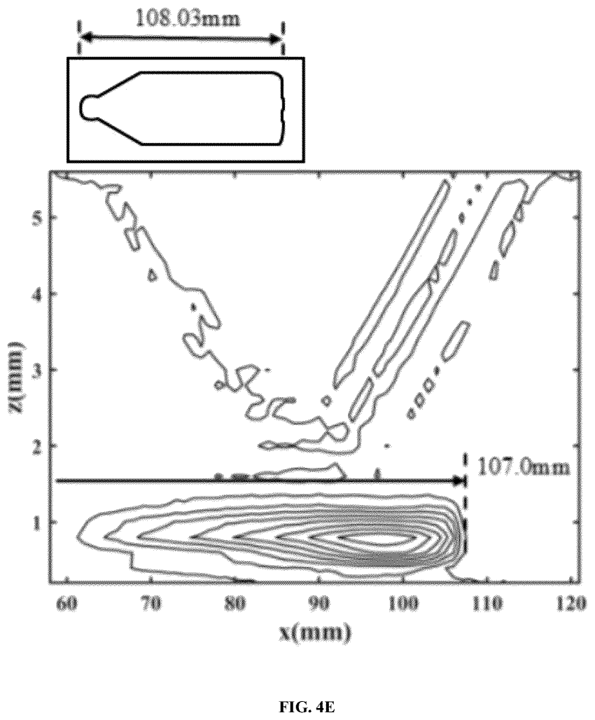

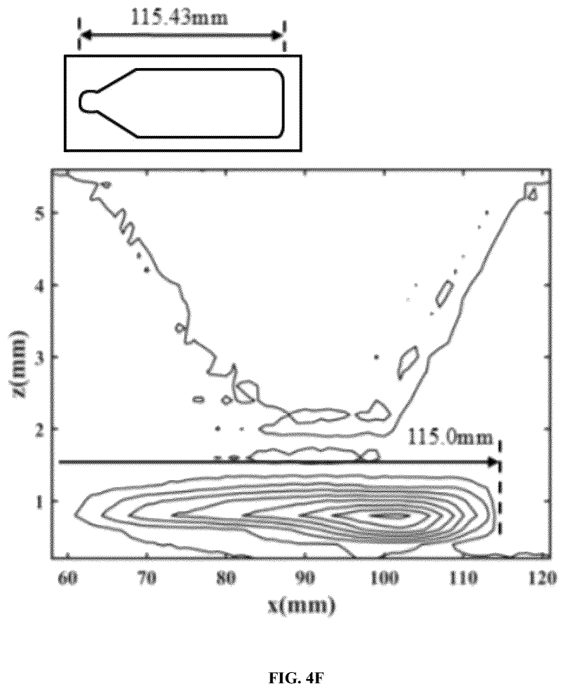

The products obtained after the injection stage and the imaging results obtained by imaging using the collected FMC data are shown in FIGS. 4A-4F. As can be seen from FIGS. 4A-4F, in all cases, a clear melt bottom image is obtained at z=5 mm, which is consistent with the product thickness. A right boundary of the image reflects a position of a front end of the melt. As can be seen from FIGS. 4A-4F, the melt front position measured by the online measurement method provided in this embodiment is consistent with an actual length of a product, with an average error of 0.5 mm.

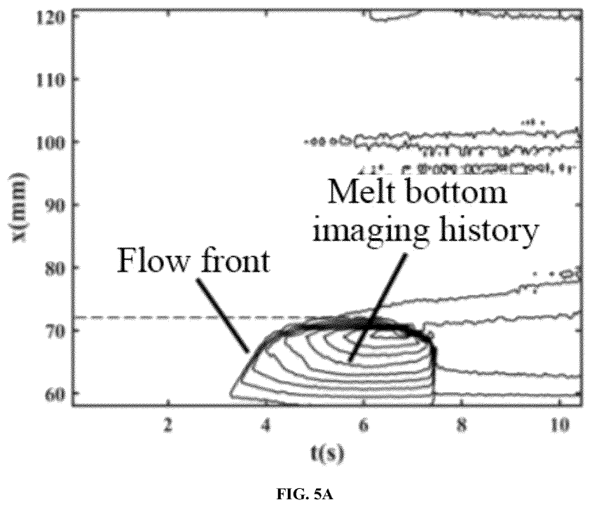

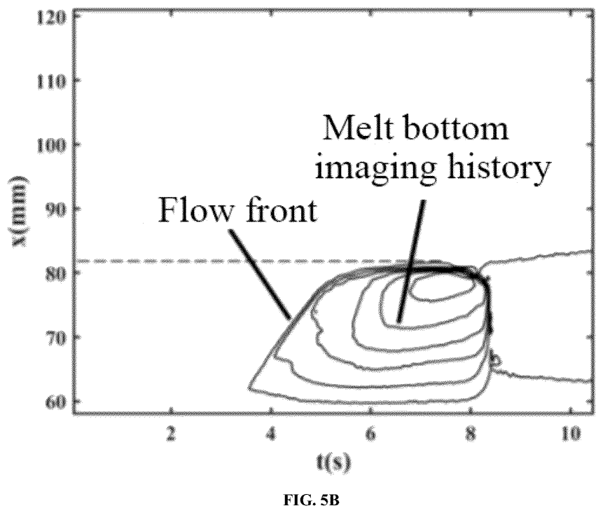

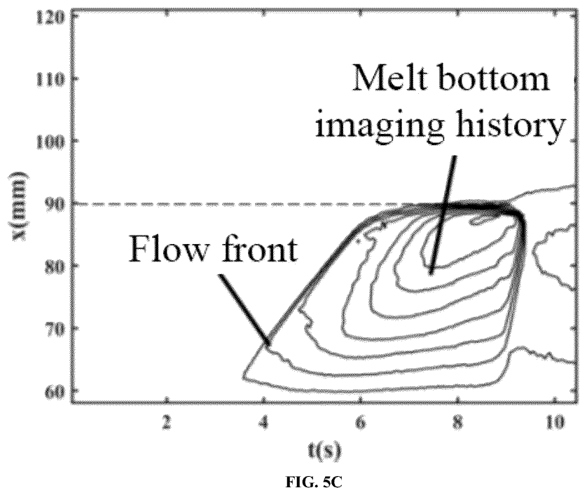

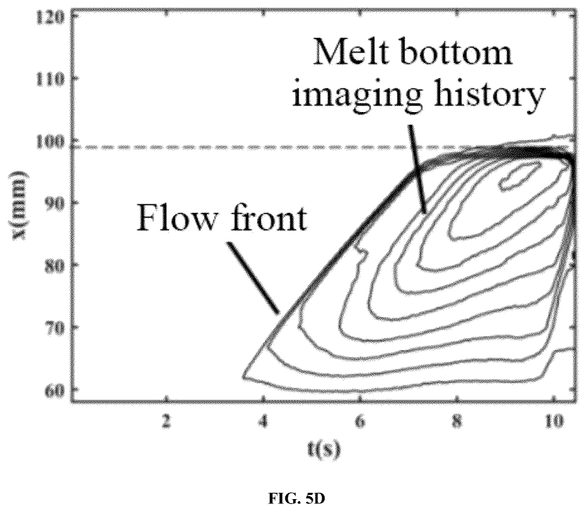

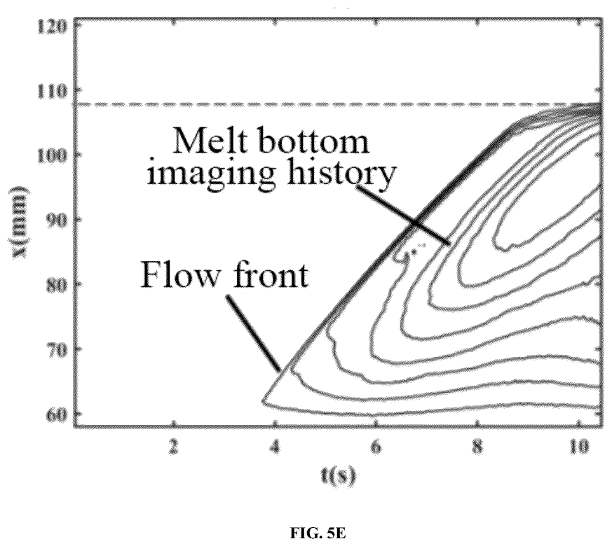

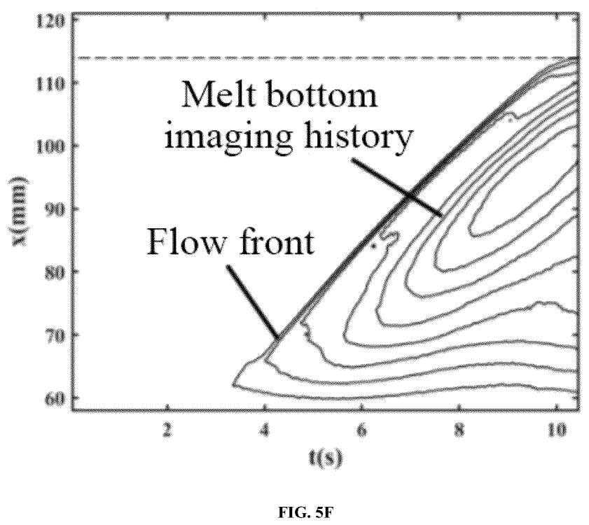

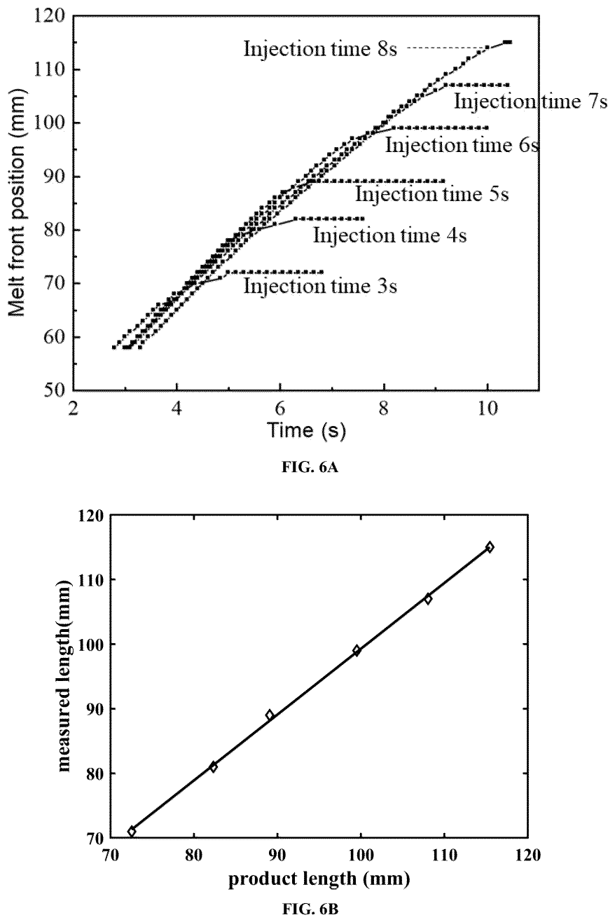

As can be seen from FIGS. 5A-5F, the melt front position is mainly reflected by the melt bottom image, i.e., the intensity of the pixel at z=5 mm. As each piece of FMC data can produce an image result, the injection process can be displayed intuitively by collecting the pixel intensity at z=5 mm in all image results, which is defined as the melt bottom image history. FIGS. 5A-5F clearly show a bottom image history and a melt front position history in the whole measurement process. As can be seen from FIGS. 6A-6B, the molten polymer advances at an almost uniform velocity and stops after reaching the injection time. The melt front position history in all cases can be extracted, as shown in FIG. 6A. In addition, the position with a slope of 0 in the melt front position history can reflect the length of the short-shot product. In addition, a relationship between the measurement length and the product length is as shown in FIG. 6B, and the linear fitting of scattering points produces a slope k of 1.0194, the linearity (R²) is 0.9992, and the slope is very close to 1, which proves the high accuracy of the online measurement method provided by this embodiment from another perspective.

### 2. Monofactor Experiment of Injection Velocity

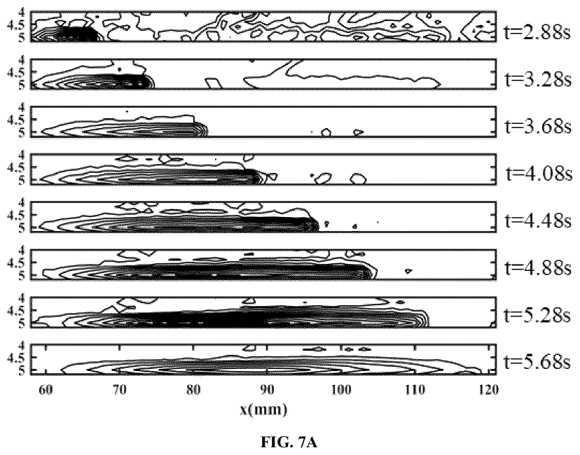

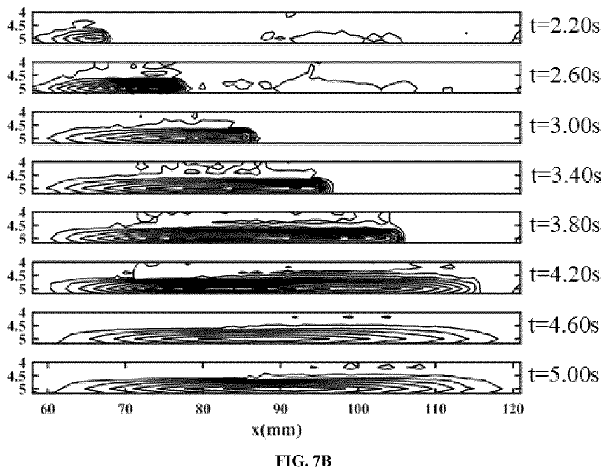

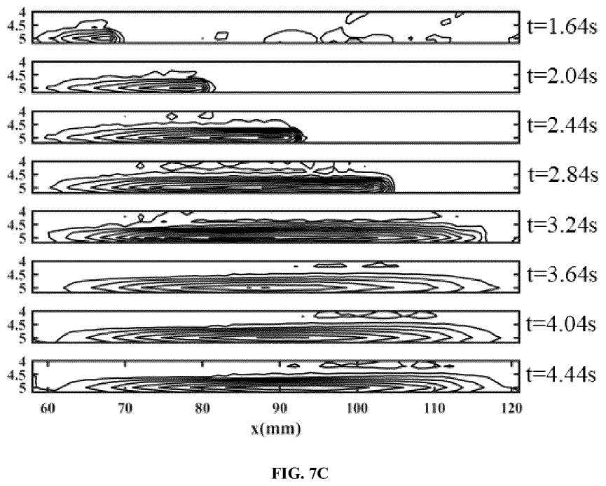

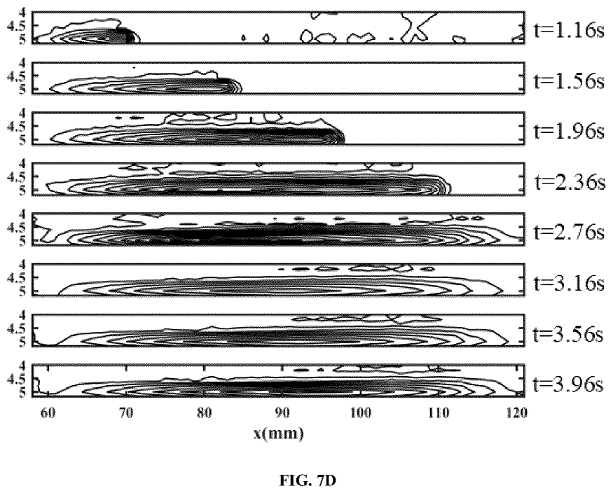

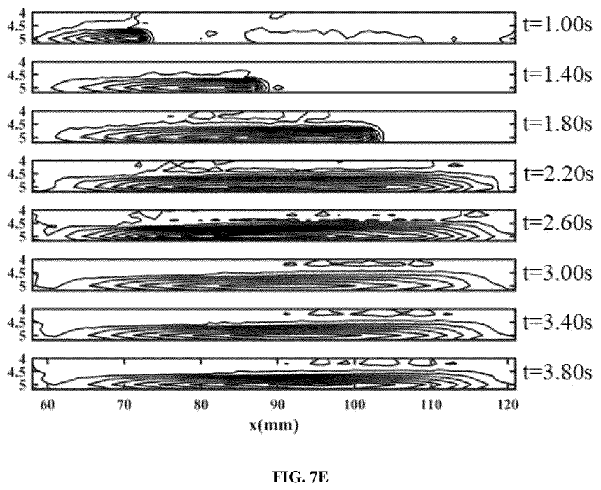

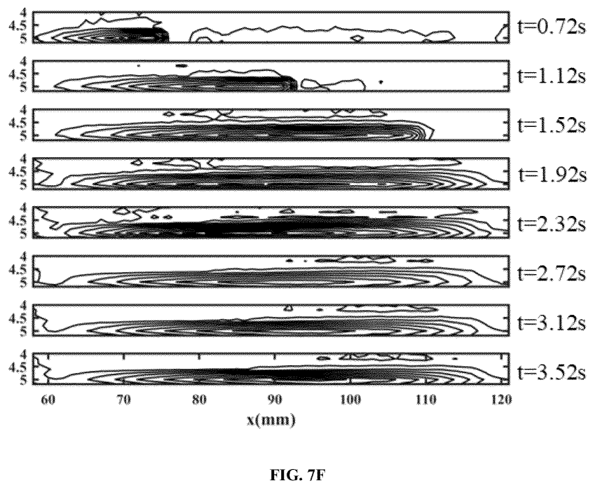

The measurement accuracy of the melt velocity by an ultrasonic method is verified by setting different injection velocities. The injection velocity is increased from 4% to 9%, the injection time is set to be 8 s, and the rest process parameters are the same as those in the short-shot experiment. Full matrix data (FMC data) is collected every 0.04 s, with the total sampling time of 8 s. An imaging result at each moment achieves the visualization of the melt flow process in the mold. At different injection velocities (4%, 5%, 6%, 7%, 8%, and 9%), the time for the polymer melt to reach a first element of the phased array is 2.48 seconds, 1.80 seconds, 1.24 seconds, 0.76 seconds, 0.6 seconds and 0.32 seconds, respectively. After the melt reaches the first element, a partial image of melt bottom is collected every 0.4 s, as shown in FIGS. 7A-7F, which is used to compare measurement results at different injection velocities intuitively. As can be observed from FIGS. 7A-7F, the flow distance increases with the increase of the injection velocity in the same time interval. When the injection velocity is 8%, the flow distance of the melt is almost twice the flow distance when the injection velocity is 4%.

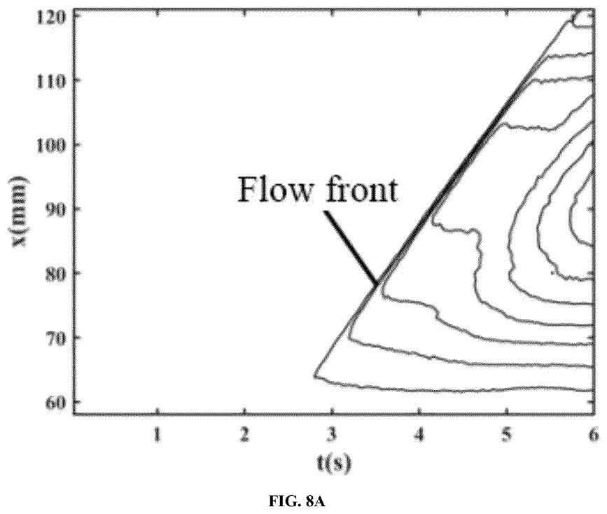

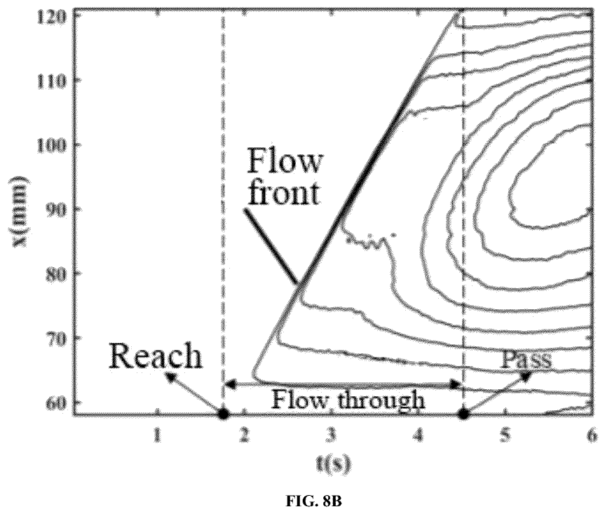

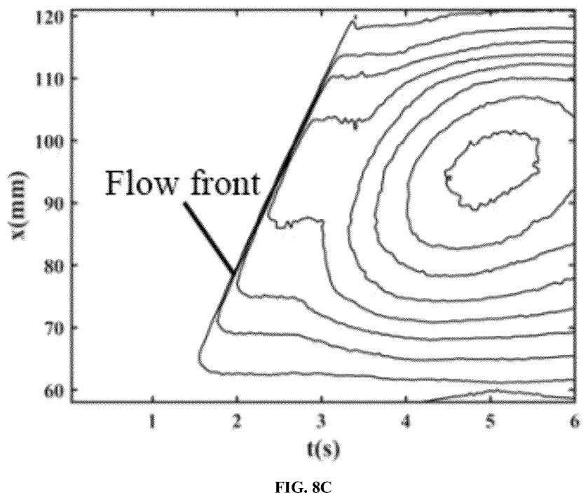

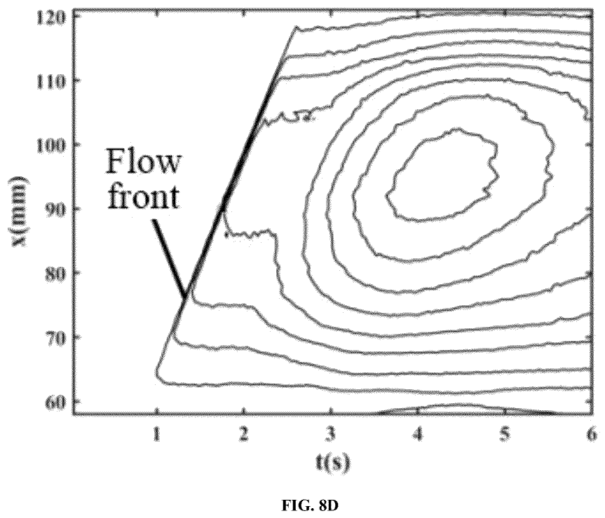

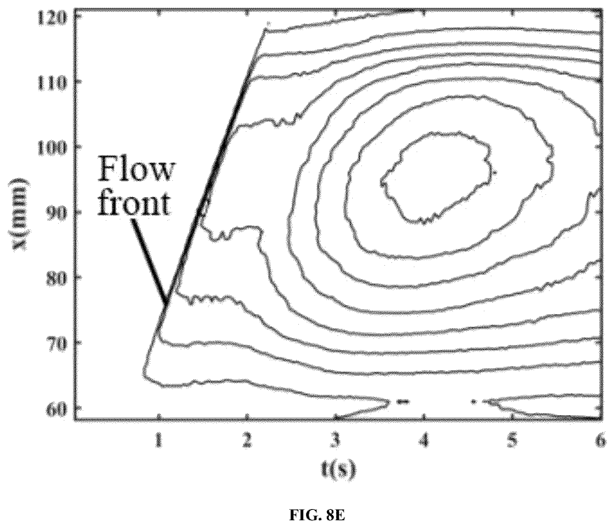

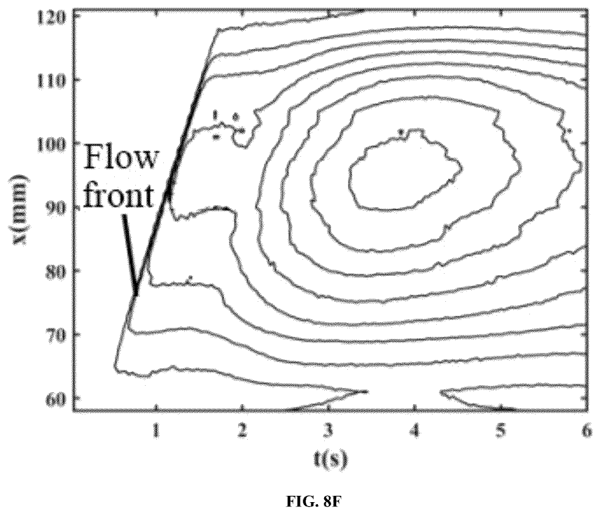

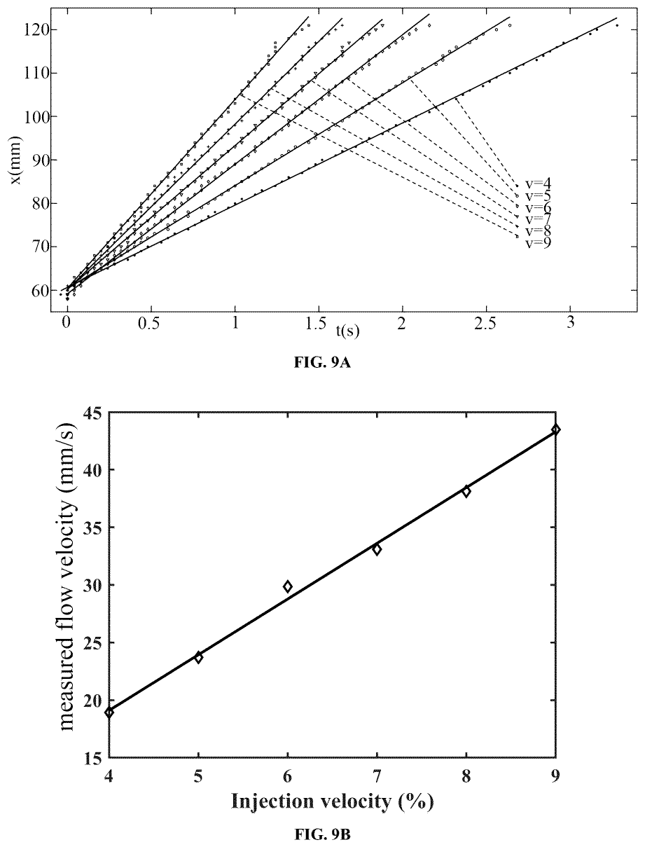

The melt bottom imaging history at different injection velocities is shown in FIGS. 8A-8F. As can be seen from FIGS. 8A-8F, in all cases, the melt front position increases linearly with the injection time, and the slope of the melt front position increases obviously with the injection velocity. As can be seen from FIG. 8B, the melt reaches the first element of the phased array in 1.8 s, and completely flows through the phased array probe in 4.5 s. Therefore, the melt bottom history can intuitively reflect the flow process of the melt, which is more convenient than a video. In addition, the melt front position history in all cases is extracted, and is subjected to linear fitting by using a RANSAC (RANdom Sample Consensus) method, as shown in FIG. 9A. As shown in FIG. 9B, there is a strong linear relationship between the measured melt flow velocity and the injection velocity, which proves the high accuracy of the on-line measurement method provided in this embodiment in melt velocity measurement.

TABLE 2
Slope and linearity of melt front history
at different injection velocities

| | Injection velocity | | | | | |
|---|---|---|---|---|---|---|
| | 4% | 5% | 6% | 7% | 8% | 9% |
| Slope (mm/s) | 18.81 | 23.74 | 29.58 | 33.60 | 37.40 | 43.34 |
| R² | 0.9996 | 0.9996 | 0.9993 | 0.9993 | 0.9992 | 0.9992 |

The slope and linearity of the melt front history in all cases are listed in Table 2, where R² is very close to 1 in all cases, indicating that the linearity and fitting accuracy are particularly high. This slope characterizes the flow velocity of the melt in the cavity, and thus the method can be used for direct measurement of the melt flow velocity in the cavity.

What is claimed is:

1. An ultrasonic phased array-based in-situ imaging method for melt flow in injection molding, comprising:
(1) collecting Full matrix capture (FMC) data of a multi-layer structure during injection;
(2) inputting sound velocity and a thickness of each layer in the multi-layer structure to calculate a propagation displacement distribution in a measurement region;
(3) acquiring an incident angle distribution in the measurement region by inversely mapping the propagation displacement distribution in the measurement region, and calculating time delay in the measurement region according to the incident angle distribution;
(4) performing imaging processing on the FMC data using a total focusing imaging condition according to the obtained time delay, so as to obtain a melt bottom image;
(5) integrating imaging results of all moments during the injection to synthesize a melt flow front video for visualization of a melt marching process; and
(6) extracting a melt bottom imaging history, a melt front history and melt flow velocity from the obtained melt flow front video to achieve melt in-situ imaging.

2. The method according to claim 1, wherein a calculation equation of the propagation displacement distribution f(θ₁, d_{(k,z)}) in the measurement region is as follows:
$$f ( {θ}_{1} , {d}_{( k , z )} ) = {\sum }_{m = 1}^{k - 1} {d}_{m} tan [ {sin}^{- 1} ( \frac{{c}_{m} sin {θ}_{1}}{{c}_{1}} ) ] + {d}_{( k , z )} tan [ {sin}^{- 1} ( \frac{{c}_{k} sin {θ}_{1}}{{c}_{1}} ) ]$$
in the equation, k denotes a number of layers of the multi-layer structure, dₘ denotes a thickness of a m-th layer, cₘ denotes sound velocity of the m-th layer, c₁ denotes sound velocity of a first layer, θ₁ denotes an incident angle, and d_{(k,z)} denotes a depth of the measurement region.

3. The method according to claim 1, wherein a calculation equation of the time delay t_{delay} is as follows:
$${t}_{delay} = {\sum }_{m = 1}^{k - 1} \frac{{d}_{m}}{{c}_{m} \cdot cos [ {sin}^{- 1} ( \frac{{c}_{m} sin {θ}_{1}}{{c}_{1}} ) ]} + \frac{{d}_{( k , z )}}{{c}_{k} \cdot cos [ {sin}^{- 1} ( \frac{{c}_{k} sin {θ}_{1}}{{c}_{1}} ) ]}$$
in the equation, k denotes a number of layers of the multi-layer structure, dₘ denotes a thickness of a m-th layer, cₘ denotes sound velocity of the m-th layer, c₁ denotes sound velocity of a first layer, θ₁ denotes an incident angle, and d_{(k,z)} denotes a depth of the measurement region.

4. The method according to claim 1, wherein an imaging condition for performing imaging processing on the FMC data using a total focusing method according to the obtained time delay is as follows:
$$I ( x , z ) = \vert {\sum }_{s = 1}^{N} {\sum }_{r = 1}^{N} \hat{D} ( {x}_{r} , {x}_{s} , {t}_{delay} ( x , z , {x}_{r} , {x}_{s} ) ) \vert$$
in the equation, I(x, z) denotes an imaging result, t_{delay} denotes the time delay, xₛ denotes a position of a s-th exciting element, and xᵣ denotes a position of a r-th receiving element, N denotes a number of elements, x denotes a coordinate in a horizontal direction, and z denotes a depth;
$$\hat{D} ( {x}_{r} , {x}_{s} , t ) = D ( {x}_{r} , {x}_{s} , t ) + iH [ D ( {x}_{r} , {x}_{s} , t ) ]$$
D(xᵣ, xₛ, t) denotes the FMC data, i is an imaginary unit, and H denotes Hilbert transformation.

5. The method according to claim 1, wherein in Step (6), the melt bottom imaging history is obtained by integrating pixel intensities of all imaging results at the melt bottom position; the melt front history is obtained by extracting a melt front position corresponding to each time point from the melt bottom imaging history; and the melt flow velocity is obtained by solving a slope of the melt front history.
